(19) United States
(12) Patent Application Publication
(10) Pub. No.: US 2009/0311437 A1
(43) Pub. Date: Dec. 17, 2009

(54) PROCESS

(75) Inventor: Ian Robert Wheeler, By Kinross (GB)

Correspondence Address: NIXON & VANDERHYE, PC, 901 NORTH GLEBE ROAD, 11TH FLOOR, ARLINGTON, VA, 22203, US

(73) Assignee: DUNWILCO (1198) LIMITED, Edinburgh (GB)

(21) Appl. No.: 12/373,806

(22) PCT Filed: Jul. 10, 2007
(86) PCT No.: PCT/GB2007/002578

§ 371 Date: Jan. 23, 2009

(30) Foreign Application Priority Data
Jul. 17, 2006 (GB) 0614167.5

(51) Int. Cl. H05H 1/00; B05D 5/00

(52) U.S. Cl. 427/535; 427/197; 427/199

(57) ABSTRACT

The invention relates to a process of preparing flakes, the process comprising the steps of: (i) applying a masking agent to a portion of a collecting substrate to provide a masked portion and an unmasked portion of the collecting substrate; (ii) applying a flake precursor to the unmasked portion of the collecting substrate to provide a plurality of flakes attached to the collecting substrate; and (iii) recovering the flakes. The invention also relates to: flakes obtained by said process; a pigment comprising said flakes; a surface coating comprising said flakes; and a use of said flakes as a pigment.

The present invention provides a process of preparing particulate products, in particular a process of preparing particulate products having a narrow particle size distribution. The particulate products prepared by the process find use in aesthetic and functional applications, especially as pigments.

Particulate products may have a variety of geometries, depending on the intended application. For example, in the pigments field, they may be substantially spherical, as in the surface polished products of EP0651777 or they may be flake shaped to better reflect light.

Commercially available flake particles are of two main types, metallic and non-metallic. They encompass a wide range of particle sizes, from 5 μm to 1000 μm or more in diameter, with aspect ratios (the ratio of the largest dimension to the smallest; effectively the diameter to thickness ratio) of 5:1 or above, for instance about 15:1 to around 150:1 or even up to 250:1 or more. Such particles find use for the coloration of inks, paints, plastics and powder coatings, to impart an appearance not attainable from non-flake, organic or inorganic pigments. Depending on their chemical composition, they may also have a number of functional applications, such as electrical conductivity, heat and light reflection, moisture barrier or flame retardancy.

For many applications, it is advantageous for the flake particles to be of uniform size, particularly when used as pigments. For example, in gravure printing applications, excessively large flakes may block the printing cells, thereby reducing the quality of print. In contrast, very small flakes can reduce the cleanliness of tone of coatings in which they are incorporated. Indeed, the brightest effects are generally derived from a narrow particle size distribution; that is to say, from a product incorporating neither very large, nor very small flakes.

The preparation of metal flake particles, for example for use as pigments, is well documented in the patent literature. They may be prepared from metal powder in the complete absence of solvent by a dry ball milling process, but this can be hazardous in the case of reactive metals such as aluminium, due to the contaminating and/or explosive properties of the dry flakes. For such metals, dry milling has been largely superseded by wet ball milling processes in which metal powder is milled with an organic liquid such as mineral spirits and a small amount of a lubricant. The cascading action of grinding media within the ball mill causes the substantially spherical metal powder to be flattened out into flakes having the recited aspect ratios.

Irrespective of the method of milling, the most common starting material is atomised metal powder. This is prepared by melting the bulk metal then forcing it through a nozzle by means of compressed gas, a process that naturally gives rise to a wide particle size distribution Thus bulk metal is converted to powder requiring further mechanical action in the ball mill to form flakes.

Older production processes produce flakes with angular edges and uneven surfaces, known in the art as “cornflakes”. A more recent development relating to aluminium is so-called “silver dollar” flakes. These are distinguished by more rounded edges, smoother, flatter surfaces and a narrower particle size distribution. In consequence, they have a brighter, whiter and more desirable appearance.

Glitter flakes are another type of commercially available pigment. These are manufactured from very thin sheets of metal or surface metallised polymer film that are cut into regular geometric shapes by mechanical action. The drawback of this technique is that it is only able to make relatively large flakes, the minimum flake size being about 50 μm.

A further process for producing metal flakes involves coating a release resin coated polymer film with a thin coating of metal using a vacuum deposition technique. The release resin coating is subsequently dissolved in a solvent to release the thin metal film that is subsequently disintegrated into flakes.

Conventional metal flake particles have a wide particle size distribution, consequent upon the wide particle size distribution of the atomised metal powder starting material. The particle size distribution of typical conventional metal flake particles is shown in Table 1. In use as pigments, the coarser flakes provide a sparkling effect, but little hiding power (opacity). In contrast, the finer flakes contribute opacity, but are of darker appearance. In practice, flake pigment manufacturers strive to produce products with a narrower particle size distribution, as in so doing, the aesthetic effect is maximised.

With the exception of glitter flakes prepared by the recited cut film process, creation of a substantially monodisperse product is not possible using the above-described conventional methods of preparing flake pigment. Creation of a substantially monodisperse product with a particle diameter below about 20 μm is not commercially feasible using any of the above-described conventional methods of preparing flake pigment.

The present invention overcomes the problems of the prior art.

### DISCLOSURE OF THE INVENTION

In a first aspect, the present invention provides a process of preparing flakes, the process comprising the steps of (i) applying a masking agent to a portion of a collecting substrate to provide a masked portion and an unmasked portion of the collecting substrate; (ii) applying a flake precursor to the unmasked portion of the collecting substrate to provide a plurality of flakes attached to the collecting substrate; and (iii) recovering the flakes.

In a second aspect, the present invention provides flakes obtained or obtainable by the process of the present invention.

In a third aspect, the present invention provides flakes having a median particle diameter of 100 μm or less and a particle size distribution such that at least 90% by volume of the flakes have a particle diameter within ±25% of the median particle diameter.

In a further aspect, the present invention provides use of flakes prepared by the process of the present invention as a pigment; for an electrically conductive pigment; for electro magnetic interference (EMI) shielding; or for providing gas barrier and/or liquid barrier properties to a surface coating or food packaging.

### DETAILED DESCRIPTION

### Process

As previously mentioned, in a first aspect, the present invention provides a process of preparing flakes, the process comprising the steps of (i) applying a masking agent to a portion of a collecting substrate to provide a masked portion and an unmasked portion of the collecting substrate; (ii) applying a flake precursor to the unmasked portion of the collecting substrate to provide a plurality of flakes attached to the collecting substrate; and (iii) recovering the flakes.

The term “flake” as used herein refers to a particle having an aspect ratio of at least 3:1 wherein the aspect ratio is defined as the ratio of the largest dimension to the smallest dimension. In one preferred aspect, the flakes have an aspect ratio of at least 5:1. According to a preferred aspect of the invention the flakes have a substantially circular face and the aspect ratio is then the ratio of the diameter of the circular face to the thickness.

The term “unmasked portion” as used herein refers to an array of discrete areas of the collecting substrate to which the masking agent is not applied.

The process of the present invention is advantageously carried out in a vacuum coater such as the Holosec vacuum coater available from General Vacuum Equipment Ltd.

In a preferred embodiment, the collecting substrate is drawn through a masking station in which the masking agent is applied. The collecting substrate is then drawn through a deposition station in which the flake precursor is applied. Following that step, the collecting substrate is drawn through a recovery station in which the flakes are recovered.

The collecting substrate may, for example, be drawn from an unwind roll through the masking, deposition and recovery stations and then drawn onto a rewind roll and then optionally re-used in the first step of the process. Alternatively the collecting substrate may be or may be on a conveyer belt that passes through the masking, deposition and recovery stations. Indeed the entire process is well suited to continuous operation, with the resulting economies of production.

When the collecting substrate is drawn from roll to roll, it is preferably drawn at as fast a rate as possible, thereby to maximise productivity, for example a rate of between 50 m/min and 300 m/min, such as around 200 m/min.

### Masking Agent

As previously mentioned, the masking agent is applied to a portion of the collecting substrate. Preferably the masking agent is printed onto the collecting substrate. For example the masking agent may be continuously printed onto a collecting substrate in the Holosec vacuum coater.

The masking agent may be printed onto the collecting substrate by any suitable printing method. Printing methods include intaglio printing, relief printing such as flexography, ink jet printing, lithography, such as offset lithography and screen process printing.

According to one embodiment the masking agent is printed by ink jet printing. Ink jet printers of the continuous ink jet (CIJ) or drop-on-demand (DOD) types may be used.

Application of the masking agent provides a masked portion and an unmasked portion of the collecting substrate. The unmasked portion of the collecting substrate is an array of discrete areas. These areas are preferably of substantially uniform shape and size. These areas may, for example, be circular in shape and may have a diameter of 10 to 30 μm. Thus the masking agent is typically applied in a pattern that produces a suitable array of unmasked areas.

The masking agent acts by preventing adhesion of the flake precursor to the masked portion of the collecting substrate. The masking agent typically evaporates during application of the flake precursor to the collecting substrate, but may also be removed by washing with a solvent. In this latter case, the masking agent may optionally remain associated with the particulate product in its final application.

The masking agent is preferably a perfluorinated polyether such as a Fomblin fully fluorinated pump oil available from BOC® Edwards.

### Collecting Substrate

Examples of suitable collecting substrates include polytetrafluoroethylene (PTFE), polyethylene, polypropylene, flexible polyester films, polyimide films such as Kapton® by Dupont, silicone rubber, metal, glass or ceramic surfaces and substrates having release layers, such as organic release layers. The metal, glass or ceramic surfaces may be optionally polished to enhance their release properties.

The flakes may be expected to adopt the surface contours of the substrate. Therefore, the collecting substrate preferably has a smooth surface, thereby providing flakes with a high degree of reflectivity. Alternatively, the surface of the collecting substrate may be engraved, for example with parallel lines, optionally by means of a laser, thereby generating flakes having novel surface colour effects. It is also advantageous if the collecting substrate has a low friction coefficient such that the flakes may be readily removed from it in the later stages of the process. In this aspect PTFE and silicone rubber are particularly preferred substrates. Silicone rubber is particularly advantageous because it exhibits good wetting, low adhesion, which aids removal of the flakes, and an extremely flat surface, which produces a very smooth and hence highly reflective surface on the flakes.

As previously mentioned, the collecting substrate may be drawn through the masking station, the deposition station and the recovery station in a continuous process. In this aspect it is therefore desirable for the collecting substrate to be flexible, as a flexible substrate can readily be used as a conveyer belt or be drawn from roll to roll. Of course rigid substrates may be incorporated in conveyer belts by configuring them as strips transverse to the belt's direction of movement. These strips preferably abut tightly at the point at which flake precursor makes contact with the collecting substrate. In general, however, flexible substrates are preferred. Silicone rubber is an example of a flexible substrate. Further examples include flexible films such as polymer films. For example, a saturated polyester film such as polyethylene terephthalate (PET) film, or polyethylene or polypropylene films may be mentioned.

In another embodiment the collecting substrate may be or may have a release layer. The term “release layer” as used herein means a pre-applied release layer, designed to be subsequently dispersed or dissolved in a liquid, in order to release the flakes. The release layer is typically a resin or polymer deposited from solution or suspension in a volatile liquid that can be re-dispersed or re-dissolved in the same or another liquid. One suitable collecting substrate is paper, pre-coated by a release layer of dry Hi-Selon C-200 polyvinyl alcohol, (available from British Traders & Shippers Ltd.) deposited from aqueous solution. Another example is a solution of PVP (polyvinyl pyrrolidone) K15 that is coated onto Melinex® film and allowed to dry.

In a preferred embodiment, the collecting substrate is subjected to a plasma pre-treatment prior to application of the flake precursor. This may be carried out by contacting a plasma discharge gas with the collecting substrate. For suitable collecting substrates, this has the effect of charging up the moving collecting substrate.

The plasma pre-treatment may be used to alter the adhesion of the flakes to the collecting substrate, in particular when the flake precursor is a metal or metal compound that is applied by vacuum deposition. Thus plasma pre-treatment may be used to improve the adhesion of vacuum deposited material to low energy polymer substrates such as polyethylene and polypropylene. Adjusting the adhesion of the flakes to the collecting substrate may be useful to ensure that the flakes adhere to the collecting substrate initially but are readily removed from it during the recovery step.

### Flake Precursor

The flake precursor may be a metal, a metal compound or a non-metal. In a broad aspect the flake precursor is any material that is capable of being applied to the unmasked portion of the collecting substrate to provide a plurality of flakes.

According to one embodiment, the flake precursor is a metal or a metal compound.

In one aspect the flake precursor is a metal. Preferably the metal is aluminium, zinc, copper, tin, nickel, chromium, silver, gold, iron or an alloy thereof. In one preferred aspect, the metal is aluminium.

In one aspect the metal is an alloy comprising two or more of aluminium, zinc, copper, tin, nickel, chromium, silver, gold and/or iron.

In another preferred aspect, the flake precursor is a metal compound. Preferably the metal compound is selected from compounds of aluminium, zinc, copper, tin, nickel, chromium, silver, iron, titanium, manganese, molybdenum and silicon.

More preferably the metal compound is a metal oxide or a metal sulfide. In one preferred aspect, the metal compound is a metal oxide selected from oxides of aluminium, zinc, copper, tin, nickel, chromium, silver, iron, titanium, manganese, molybdenum and silicon. In another preferred aspect, the metal compound is a sulfide, such as cerium sulfide, cadmium sulfide, or chromium sulfide. The inherent colour of certain metal compounds is advantageous in creating flakes with novel appearance.

Further metal compounds which may be used are inorganic phosphates and chromates which may act as passivators. In one preferred aspect the metal compound is a mixture of copper and zinc compounds.

According to a further embodiment, the flake precursor is a non-metal.

Examples of suitable non-metal flake precursors include precursors of glass flakes such as sol gels, low melt temperature glass or other ceramic compositions, organic silicates such as tetraethyl orthosilicate, inorganic silicates, such as alkali metal silicates and other film-forming inorganic compounds, solid and liquid resins and polymers, solutions such as resin or polymer solutions and precursors of synthetic bismuth oxychloride flakes, such as bismuth nitrate.

Preferably the non-metal flake precursor is a sol gel, a resin, a polymer liquid, a solution such as a resin or polymer solution, or bismuth nitrate solution. It is further preferred that the flake precursor is of good thermal and chemical stability.

The resin may advantageously be an electron beam or UV/IR curable resin, such as an acrylic resin, or a thermosetting resin, such as an epoxy resin or an air drying resin, for example a polysiloxane resin, of which the Silikophen products of Tego Chemie GmbH are examples. Examples of liquid thermoset phenolic resins are products of Tipco Industries Ltd, TPF/S/1517 and TPF/F/151. Examples of UV curable resins are acrylates, epoxy acrylates, urethane acrylates, polyester acrylates, polyether acrylates and other functional monomers and oligomers. As examples of UV curable resins, the Ebecryl products of UCB (Chem) Ltd, Laromer products of BASF AG or the Sarbox oligomers of the Sartomer Company Inc may be mentioned. Alternatively, the resin may be a solution of non-UV curable hard resins and/or polymers.

In one embodiment, the non-metal flake precursor comprises a fine dispersion of organic or inorganic colorants. This embodiment is particularly preferred when the flakes are to be used as a pigment, for example by dispersion in a pigment carrier. In this embodiment the flakes need not be coated since their colour can be controlled by selection of appropriate colorants. The organic or inorganic colorants may also be used as a means of controlling the brittleness of the flakes.

Certain flake precursors may need to be subjected to a solidification treatment to provide flakes. This is particularly applicable to certain non-metal flake precursors.

The solidification treatment may be any suitable physical or chemical means or a mixture of both. Examples of suitable physical means may include heating and cooling. Examples of suitable chemical means include chemical reactions resulting from UV curing, heating, treatment with steam, treatment with ammonia vapour, treatment with hydrogen chloride gas or a mixture thereof.

In particular, the solidification treatment may be a thermal, chemical or irradiative treatment or a combination thereof. Examples of suitable thermal treatments include heating and cooling, such as air-cooling. Examples of suitable chemical treatments include treatment with steam, treatment with ammonia vapour, treatment with hydrogen chloride gas or a mixture thereof. Examples of suitable irradiative treatments include the application of electromagnetic radiation or particle radiation such as ultraviolet (UV) and electron beam (EB) curing and laser curing. A further example of a solidification treatment is vacuum treatment.

The solidification treatment will depend on the nature of the non-metal flake precursor. For example, when the non-metal flake precursor is a UV or IR curable resin, UV or IR curing may advantageously be used as the solidification treatment. UV or IR lamps may be used to carry out the solidification treatment. When the non-metal flake precursor is tetraethyl orthosilicate, the solidification treatment may be treatment with an atmosphere of steam and ammonia vapour to fuse the tetraethyl orthosilicate to silica and optionally subsequent heat treatment to form glass. If bismuth nitrate is used as the non-metal flake precursor, the droplets may be heated to around 400° C. and treated with a mixture of hydrogen chloride gas and air.

Preferably a thermally durable collecting substrate is utilised when the solidification treatment includes heating.

### Applying the Flake Precursor

According to a preferred embodiment of the present invention, the flake precursor is applied to the collecting substrate by vacuum deposition.

This aspect is particularly applicable when the flake precursor is a metal or metal compound. However, any non-metal flake precursor that is capable of being applied by vacuum deposition may also be applied in this manner. Such non-metal flake precursors may include suitable monomers or polymers such as styrene polymers, acrylic resins or blends thereof. Cellulosics may also be used. Teflon® is a further non-metal flake precursor that is capable of being applied by vacuum deposition.

According to this embodiment the step of applying the flake precursor to the collecting substrate is carried out under at least a partial vacuum. The flake precursor is typically contained in a vessel in the deposition station of an apparatus. The deposition station is evacuated to create an at least partial vacuum. The vessel is heated until the flake precursor sublimes or evaporates to produce a cloud of particles that are subsequently deposited on the collecting substrate in the form of flakes.

A further means of applying the flake precursor to the collecting substrate is by ink-jet printing. Ink-jet printing of the flake precursor is particularly preferred when the flake precursor is a non-metal flake precursor.

### Recovery

The flakes may be recovered from the collecting substrate by any one of a number of different means or by a combination of different means. For example, the flakes may be recovered by using sound waves (ultrasonics) or a scraping device such as a doctor blade. Alternatively, the flakes may be recovered from the collecting substrate by means of a jet of liquid or air at elevated pressure. In a further option, the collecting substrate may be locally stretched to facilitate flake release.

According to one embodiment, the flakes are recovered by means of high-pressure water or solvent jets, which are particularly suitable for use in a continuous process. A further means of recovering the flakes is by washing with a recovery liquid. Recovery methods involving the use of recovery liquids are generally unsuitable for operation in a partial or high vacuum environment. In such cases, flake formation may be carried out under vacuum on a collecting substrate configured in roll-to-roll mode. The roll of flake-coated collecting substrate film may then be removed from the vacuum chamber and unrolled through the recovery station at atmospheric pressure. Providing it does not react undesirably with the flakes, water or any common organic compound finding use as a solvent may be employed as a recovery liquid. In one preferred embodiment the recovery liquid is water, optionally containing a metal passivating agent.

Alternatively, when the collecting substrate has or is a release layer, the release layer may be dispersed or dissolved in a recovery liquid. It may be advantageous to use as a release layer a material that contributes to the final application; for example a resin that in a derived surface coating becomes a permanent, film-forming part of that coating. It may be advantageous to use a recovery liquid that contributes to the final application, for instance by fulfilling a further useful role in post-treating or facilitating post-treatment of the flakes. Therefore, the recovery liquid may be selected for its chemical reaction with the flakes if it is being used to treat the flakes. Alternatively, the recovery liquid may be selected for being chemically inert with respect to the flakes. These two aspects may be combined so that both the recovery liquid and release layer contribute to the final application.

In one aspect the flakes in the recovery liquid may be in a form convenient for sale or for further processing. This may be achieved by using a recovery liquid that is compatible with the envisaged application. For certain applications, it may be necessary to concentrate the flakes in the recovery liquid, for example to form a conventional flake paste for ease of handling. Where this is the case, a filter press or other known well-known means of separating solid particulates from liquids may be used.

Use of a recovery liquid has the advantage of removing the problem of dust contamination of the workplace.

To render the flakes prepared by the process of the invention compatible with plastics and certain printing inks, it is necessary to avoid high boiling recovery liquids, either by dry recovery of the flakes or through their conversion into a liquid free form, such as granules, using for example the process described in European Patent 0134676B. If desired, the flakes may be immobilised by solid organic carrier material.

### Milling

In one aspect, the process further comprises a milling step.

The term “milling” as used herein includes any mechanical work performed so as to deform the flakes, by moving milling media, for instance, by conventional ball milling or by roll milling, such as with a nip roll.

Milling of the flakes may take place at any stage in the process. In particular, milling may take place either whilst the flakes are still on the collecting substrate or following their removal from the collecting substrate. The flakes should be sufficiently malleable to undergo physical deformation during the milling step. Thus milling of certain non-metal flakes may not be feasible.

According to one embodiment, the flakes are milled whilst still on the collecting substrate. In this embodiment it is advantageous if the collecting substrate is or is on the moving rolls of a roll mill. The flakes may be allowed to impinge on the moving rollers of a two or three roll mill. The nip between the rollers is set to impart pressure on the flakes, flattening them further so that they assume the contours of the rollers, which may for example be used to impart a pattern on either or both of the flake surfaces. The surface quality of the flakes and hence the reflectivity of a pigment composition in which they are incorporated is dependent on the degree of surface polish of the rollers.

### Coating

In one aspect, the present invention further comprises the step of coating the flakes. The coating step may be particularly desirable if the flakes are non-metal flakes. The non-metal flakes may then be coated with a metal and/or metal compound. Suitable metals and metal compounds are as described herein.

Coated non-metal flakes have a number of advantages over conventional metal flakes. For example, the non-metal material may be a relatively low cost material leading to a reduction in production costs. The coated non-metal flakes will also typically have significantly lower density than metal flakes with the result that they have much less tendency to settle in fluid application systems such as inks and paints. Furthermore, being of significantly narrower particle size distribution than conventional flakes, their metallic brightness is enhanced.

It is possible to undertake coating at any stage of the process provided it is compatible with the other steps adopted. For example the flakes may be coated before or after a milling step. The flakes may also be coated whilst still attached to the collecting substrate or after recovery.

If it is desirable for both sides of the flakes to be coated, then coating the flakes after removal from the substrate is generally preferred. However, if only one side of each flake is to be coated, and this is often sufficient for the desired metallic appearance of the pigment flakes, then coating prior to removal from the substrate is feasible. Coating only one side of the flake is particularly applicable when the flakes are optically transparent and is advantageous because a smaller quantity of the metal and/or metal compound is required, which leads to economic benefits.

The flakes may be coated by a number of different techniques. One method of coating the flakes involves applying a further flake precursor to the flakes whilst the flakes are still attached to the collecting substrate. This further flake precursor is advantageously applied whilst the masking agent is still masking a portion of the collecting substrate, for example before the masking agent evaporates.

Thus coated flakes may be prepared by a process comprising the steps of (i) applying a masking agent to a portion of a collecting substrate to provide a masked portion and an unmasked portion of the collecting substrate; (ii) applying a first flake precursor to the unmasked portion of the collecting substrate to provide a plurality of flakes attached to the collecting substrate; (iii) applying a second flake precursor to the flakes to provide coated flakes; and (iv) recovering the coated flakes.

It will be readily understood that step (iii) of the above process could be repeated using further flake precursors. The first, second and further flake precursors may be the same or different. Thus the flake precursors may be independently selected from non-metals, metals and metal compounds such that the flakes may be coated with layers of the same material or layers of a combination of different materials.

In one embodiment, the first flake precursor is a non-metal and the second flake precursor is selected from metals and metal compounds. Thus non-metal flakes coated with a metal and/or metal compound may be prepared. A third and further flake precursors may be applied. These flake precursors may be the same as the underlying non-metal, metal or metal compound, or a combination of different non-metals, metals or metal compounds.

In another embodiment, the first flake precursor is a metal or metal compound. In a further embodiment the flake precursors are all independently selected from metals and metal compounds, such that the coated flakes may be made up of layers of the same metal or metal compound or a combination of different metals and/or metal compounds.

The thickness and refractive index of each layer of coating may be varied. Properties, such as optical properties, of the coated flakes may be adjusted by varying the number of flake precursors, the nature of the flake precursors and/or the thickness of each layer of coating. Thus different colour effects may be achieved, including colour variable effect pigments, displaying chromatic colour variation with the angle of viewing.

The flakes may also be coated by well-known wet chemistry techniques. This may be carried out whilst the flakes are still in the recovery liquid.

Alternatively, the flakes may be recovered dry and coated by well-known vacuum deposition techniques, for example in a fluidised bed.

Digital metal deposition technology may also be used to coat the flakes. One known process involves jetting a silver, nano-particulate ink onto a material (in this case, the flakes) followed by high temperature sintering to fuse the particles.

Another coating technique involves the use of a special non-metal flake precursor that can be processed to form a semi-porous “sponge” into which the metal and/or metal compound is deposited. The flakes are formed from a flake precursor that has three components: a water-soluble UV curable component, a water insoluble UV curable component and a transition metal catalyst. On curing, the two UV curable components separate into discrete phases. The water soluble phase may be dissolved out to leave a semi-porous sponge into which the metal and/or metal compound may be deposited by electroless deposition, for example, in an electroless copper bath. This technique is described in WO-A-04068389.

The flakes may be activated prior to the coating step to make the surface more receptive to the coating. Activation is particularly applicable to non-metal flakes. Activation may consist of an acidic tin dichloride treatment that could be achieved using a bath process. A catalytically active surface may then be created in a subsequent step that consists of treatment with a solution of palladium ions, usually performed using a bath process. Surface preparation/activation steps are usually followed by rinsing steps that can be performed using low-pressure water jets.

In one preferred embodiment, the coating is carried out using an electroless bath. In this aspect, copper electroless baths and nickel electroless baths, which are widely commercially available, e.g. metal plating systems from Rohm & Haas and Technic Inc, are particularly suitable. Once an electrically conducting flake coating is in place further metal coatings could be achieved by electrolytic metal deposition.

### Further Treatment

The flakes may be passivated during their preparation by treatment with corrosion inhibiting agents, for example by the addition of one or more corrosion inhibiting agents to a recovery liquid containing the flakes. This may be particularly desirable when the flakes comprise a metal such as aluminium, zinc, copper, silver, or iron.

Any compounds capable of inhibiting the reaction of the metal and/or metal compound with water may be employed as corrosion inhibitors. Examples are phosphorus-, chromium-, vanadium-, titanium- or silicon-containing compounds. They may be used individually or in admixture.

Certain flakes comprising a metal and/or a metal compound may be treated with ammonium dichromate, or silica- or alumina-forming chemicals to improve stability in aqueous application media. Other treatments, with agents such as ammonium or potassium permanganate, may be used to provide coloration of the flake surface, for example to simulate gold. Still further treatments may improve the hardness and therefore the shear resistance of such flakes in application media.

### PREFERRED EMBODIMENTS

According to one preferred embodiment, the present invention provides a process of preparing metal flakes, the process comprising the steps of:

(i) printing a masking agent onto a portion of a collecting substrate to provide a masked portion and an unmasked portion of the collecting substrate;

(ii) applying a metal flake precursor to the unmasked portion of the collecting substrate by vacuum deposition to provide a plurality of metal flakes attached to the collecting substrate; and

(iii) recovering the metal flakes by using ultrasonics and/or a recovery liquid.

### Flakes

The process of the present invention may advantageously be used to prepare flakes having a low median particle diameter and/or a narrow particle size distribution preferably having a low median particle diameter and a narrow particle size distribution.

The term “median particle diameter” as used herein refers to a volume median particle diameter. When the flake has a substantially circular face, the particle diameter is the diameter of the circular face. Otherwise the particle diameter is the largest dimension of the flake.

Particle size distributions may be measured with a “Malvern Master Sizer 2000” which is a standard instrument for measuring volume percent particle size distributions. According to a preferred aspect, the process of the present invention may be used to prepare flakes having a median particle diameter of 1000 μm or less, preferably 100 μm or less, more preferably 50 μm or less, more preferably 30 μm or less, for instance 10 to 30 μm, and even 10 μm or less.

Preferably the median particle diameter of the flakes is from 5 to 1000 μm, such as from 5 to 500 μm, 5 to 250 μm, 5 to 150 μm, 5 to 100 μm, 5 to 50 μm or 5 to 30 μm.

Preferably the median particle diameter of the flakes is from 10 to 500 μm, such as from 10 to 250 μm, 10 to 100 μm, 10 to 50 μm or 10 to 30 μm.

In another aspect, the median particle diameter of the flakes is preferably from 80 to 1000 μm, such as from 80 to 500 μm, 80 to 250 μm, 80 to 150 μm or 80 to 100 μm.

In one aspect the median particle diameter is 100 μm or less, such as 50 μm or less, 30 μm or less, 20 μm or less, 10 μm or less or 5 μm or less.

Furthermore, the process of the present invention may be used to prepare flakes having a particle size distribution such that at least 90% by volume of the flakes have a particle diameter within ±25% of the median particle diameter, preferably within ±10%, more preferably within ±5%, such as within ±3%.

The process of the present invention may also be used to prepare flakes having a particle size distribution such that at least 95% by volume of the flakes have a particle diameter within ±25% of the median particle diameter, preferably within ±10%, more preferably within ±5%, such as within ±3%.

In a preferred aspect, the process of the present invention may be used to provide flakes having a median particle diameter of 100 μm or less, preferably 50 μm or less, preferably 30 μm or less and a particle size distribution such that at least 90% by volume of the flakes, preferably at least 95% by volume, have a particle diameter within ±25% of the median particle diameter, preferably within ±5% of the median particle diameter.

Methods traditionally used to separate wanted from unwanted particle size fractions, such as dilution with solvent, followed by wet screening, are not generally required. Further, the process of the invention essentially produces flakes having a uniform median particle diameter.

The physical form of the flakes obtained from the instant process is good and they will usually be suitable for use without further processing. For maximum brightness in pigmentary applications however, it may be advantageous to gently mill or polish the surfaces of the flakes, where the flakes-are amenable, to increase surface reflectance, for example to improve reflection of light.

As previously mentioned, the term “flake” refers to a particle having an aspect ratio of at least 3:1. Preferably the aspect ratio of the flakes is at least 5:1, more preferably at least 15:1. Higher aspect ratios are generally preferable and flakes having an aspect ratio of at least 50:1, such as 100:1 or 150:1 or above, are contemplated. Providing the flakes are sufficiently mechanically robust to withstand processing through to their final application, a high aspect ratio will maximise the desirable reflection of light per unit volume or weight of flake.

In one aspect the flakes have a substantially circular face. However, the flakes may be different shapes depending on the intended application. For example the flakes may have a substantially triangular, square, rectangular or other polygonal face, or may be in the form of rods, bars or fibres. In fact the flakes may have a face that is any shape that can be produced by the process, although the flakes will typically have a uniform thickness. The flakes may not be perfectly flat but may instead have a convex/concave face. For certain applications, in particular non-pigmentary applications, such as electrical conductivity, the flakes may advantageously be in the form of tubes or filaments. Tube-shaped flakes may be formed by planar flakes curling up. Under certain conditions, planar flakes may curl up into tube-shaped flakes spontaneously.

In one aspect the present invention provides flakes obtained or obtainable by the process of the present invention.

In another aspect, the present invention provides flakes having a median particle diameter of 100 μm or less, preferably 50 μm or less, preferably 30 μm or less and a particle size distribution such that at least 90% by volume of the flakes, preferably at least 95% by volume, have a particle diameter within ±25% of the median particle diameter, preferably within ±10% of the median particle diameter.

In this aspect, the flakes are preferably other than metal flakes or metal compound flakes. In this aspect, the flakes are preferably non-metal flakes, such as non-metal flakes that are coated with a metal and/or metal compound.

### Pigment Composition

In one aspect, the process of the present invention further comprises the step of dispersing the flakes in a pigment carrier to provide a pigment composition.

The pigment carrier may be the recovery liquid used in the recovery step. For example, the pigment carrier may be an organic liquid or water.

In a further aspect, the present invention provides a pigment composition comprising flakes obtained or obtainable by the process of the present invention or flakes as otherwise herein defined.

The pigment composition comprises flakes and a pigment carrier.

Thus, the present invention provides a pigment composition comprising flakes having a median particle diameter of 100 μm or less and a particle size distribution such that at least 90% by volume of the flakes have a particle diameter within ±25% of the median particle diameter, such as within ±10%, or within ±5%, or within ±3% and a pigment carrier.

### Surface Coating

In one aspect, the process of the present invention further comprises the step of dispersing the flakes in a surface coating material to provide a surface coating.

The flakes may be dissolved or dispersed in one or more solvents such as water and then added to a surface coating material such as a surface coating binder, to prepare a surface coating, such as an ink or paint.

The reaction of certain flakes in the surface coating, notably aluminium flakes or aluminium-coated flakes, may however be unpredictable. Where such a surface coating contains a proportion of water, there exists the possibility that reactions may occur during storage, with the formation of hydrogen gas and attendant hazards. It is therefore desirable to passivate such flakes in the manner described above.

In a further aspect the present invention provides a surface coating comprising a pigment composition as defined herein or flakes as defined herein.

### Use

The flakes of the invention may have functional and/or aesthetic applications. In one aspect, the present invention provides use of flakes obtained or obtainable by the process of the invention or as otherwise herein defined as a pigment, for instance in surface coatings or in the mass pigmentation of polymers. Flakes of good thermal stability are required for the latter.

Non-pigmentary applications of the flakes include flakes for electrically conductive applications, such as EMI shielding, as well as coatings providing a barrier to migration of gases and liquids, useful in food packaging. EMI shielding refers to the use of a material (the EMI shielding agent) to block spurious electromagnetic radiation that may interfere with the efficient operation of electrical equipment. A typical example is the use of nickel flakes in coatings applied to the insides of mobile phone and computer housings. For such electrical conductivity applications, flake particles that are long in relation to their width and thickness, or of wheel and spoke shape, may provide improved conductivity over circular flakes at a given percentage loading.

Accordingly the present invention also provides the use of flakes obtained or obtainable by the process of the invention or as otherwise herein defined for electrical conductivity or EMI shielding or for providing gas barrier and/or liquid barrier properties to a surface coating or food packaging.

The invention is further illustrated by the following Example.

### EXAMPLE 1

A roll of 12 μm PET film is spooled from roll to roll at around 200 m/min within a Holosec vacuum coater (General Vacuum Equipment Ltd.) The non-image area of the PET is continuously printed with a Fomblin fully fluorinated mechanical pump oil (BOC Edwards) to leave a network of closely spaced, 15 μm diameter circular dots. Immediately after printing, the roll is continuously spooled over a vacuum metallising head. Aluminium metal is deposited from the vapour phase onto the dots, each of which becomes a flake of very bright appearance, comparable to pigments prepared by existing vacuum deposition technology. The oil evaporates from the non-image areas, thereby preventing adhesion of the aluminium. The re-spooled roll is removed from the coater and the flakes recovered by sonication and washing by solvent or preferably water to which a passivating agent for the aluminium has been added.

The advantage of this process over existing vacuum deposited aluminium flake pigment is the tight particle size distribution and the advantage it confers in applications. Plasma pre-treatment, often used to improve adhesion of the vacuum deposited material to low energy polymer substrates, may be used to adjust adhesion of the printed dots to enable metallisation, but allow easy and complete removal thereafter at the recovery station.

TABLE 1
Typical aluminium pigment

| size (μm) | volume % | under size (μm) | volume % under |
|---|---|---|---|
| 0 | 0.00 | 16 | 74.7 |
| 1 | 0.4 | 18 | 80.5 |
| 2 | 3.1 | 20 | 84.7 |
| 3 | 6.8 | 22 | 87.8 |
| 4 | 11.4 | 24 | 91.2 |
| 5 | 17.1 | 26 | 93.1 |
| 6 | 23.0 | 28 | 94.4 |
| 7 | 29.9 | 30 | 95.5 |
| 8 | 35.5 | 34 | 97.2 |
| 9 | 41.6 | 38 | 98.0 |
| 10 | 47.9 | 42 | 98.5 |
| 12 | 58.5 | 46 | 98.7 |
| 14 | 67.4 | 50 | 98.8 |

D(10) (μm) 3.7
D(50) (μm) 10.4
D(90) (μm) 23.3

1.-45. (canceled)

46. A process of preparing flakes, the process comprising the steps of:
(i) applying a masking agent to a portion of a collecting substrate to provide a masked portion and an unmasked portion of the collecting substrate;
(ii) applying a flake precursor to the unmasked portion of the collecting substrate to provide a plurality of flakes attached to the collecting substrate; and
(iii) recovering the flakes.

47. A process according to claim 46 wherein the masking agent is a perfluorinated polyether and/or the masking agent is printed onto the collecting substrate.

48. A process according to claim 46 wherein the collecting substrate is a flexible polymer film.

49. A process according to claim 46 wherein the collecting substrate is subjected to a plasma pre-treatment prior to application of the flake precursor.

50. A process according to claim 46 wherein the flake precursor is
(i) a metal selected from aluminium, zinc, copper, tin, nickel, chromium, silver, gold, iron or an alloy thereof;
(ii) a metal compound selected from compounds of aluminium, zinc, copper, tin, nickel, chromium, silver, iron, titanium, manganese, molybdenum and silicon, or a mixture of two or more thereof; or
(iii) a non-metal which is a sol gel, a resin, a polymer, a resin or polymer solution or bismuth nitrate.

51. A process according to claim 50, wherein the metal compound is an oxide or a sulfide.

52. A process according to claim 46 wherein the flake precursor is applied to the collecting substrate by vacuum deposition.

53. A process according to claim 46 wherein the flakes are recovered from the collecting substrate by use of sound waves and/or by washing with a recovery liquid.

54. A process according to claim 53 wherein the recovery liquid is water.

55. A process according to claim 46 which further comprises the step of coating the flakes and/or the step of milling the flakes.

56. A process according to claim 46 of preparing flakes having a median particle diameter of 50 μm or less.

57. A process according to claim 46 of preparing flakes having a particle size distribution such that at least 90% by volume of the flakes have a particle diameter within ±25% of the median particle diameter.

58. A process according to claim 46 of preparing flakes having a particle size distribution such that at least 95% by volume of the flakes have a particle diameter within ±25% of the median particle diameter.

59. A process according to claim 46 of preparing flakes having a particle size distribution such that at least 95% by volume of the flakes have a particle diameter within ±10% of the median particle diameter.

60. A process according to claim 46 which further comprises the step of dispersing the flakes in
(i) a pigment carrier to provide a pigment composition; or
(ii) a surface coating material to provide a surface coating.
